(19) United States
(12) Patent Application Publication
(10) Pub. No.: US 2014/0058889 A1
(43) Pub. Date: Feb. 27, 2014

(54) CATALOG ITEM FULFILLMENT SYSTEM

(71) Applicants: Belinda Liu, Saratoga, CA (US); Roshan Patel, San Ramon, CA (US); Devarshi Vyas, San Jose, CA (US); Xin Zhuang, Fremont, CA (US); Mallikarjun Bhaigond, San Jose, CA (US); Thennarasu Ponnusamy, Sunnyvale, CA (US); Sree Gouri Pamarthy, San Jose, CA (US); Thuy D. Nguyen, San Jose, CA (US); Mayank Gupta, Milpitas, CA (US); Venkateswar Goud Bathula, Cupertino, CA (US)

(72) Inventors: Belinda Liu, Saratoga, CA (US); Roshan Patel, San Ramon, CA (US); Devarshi Vyas, San Jose, CA (US); Xin Zhuang, Fremont, CA (US); Mallikarjun Bhaigond, San Jose, CA (US); Thennarasu Ponnusamy, Sunnyvale, CA (US); Sree Gouri Pamarthy, San Jose, CA (US); Thuy D. Nguyen, San Jose, CA (US); Mayank Gupta, Milpitas, CA (US); Venkateswar Goud Bathula, Cupertino, CA (US)

(73) Assignee: eBay Inc., San Jose, CA (US)

(21) Appl. No.: 13/593,193

(22) Filed: Aug. 23, 2012

(51) Int. Cl. G06Q 30/00; G06Q 30/06

(52) U.S. Cl. 705/26.8; 705/27.1

(57) ABSTRACT

A system and method for a catalog item virtual fulfillment center is described. The system determines whether an item from a search query on an online marketplace corresponds to a catalog item. The catalog item corresponds to an item sold at substantially the same price among different sellers of the online marketplace. A display of a menu of different shipping times and corresponding total costs is generated for the catalog item.

### TECHNICAL FIELD

This application relates generally to the field of computer technology, and in a specific example embodiment, a method and system for a catalog item fulfillment system.

### BACKGROUND

Online marketplaces include many sellers listing items for sale. Buyers buy these items and sellers ship the item to the buyer upon receipt of payment. Many buyers are located across the country or across many geographical regions. For a seller offering free shipping, the shipping cost is higher to ship to a buyer geographically closer to the buyer than to another buyer further away from the seller. Furthermore, asides from shipping cost, the shipping duration increases with the shipping distance.

### BRIEF DESCRIPTION OF THE DRAWINGS

The present invention is illustrated by way of example, and not by way of limitation, in the figures of the accompanying drawings in which:

FIG. 1 is a network diagram depicting a network system, according to one embodiment, having a client-server architecture configured for exchanging data over a network;

FIG. 2 shows a block diagram illustrating one example embodiment of a marketplace application;

FIG. 3 shows a block diagram illustrating one example embodiment of a catalog item virtual fulfillment center application;

FIG. 4 shows a block diagram illustrating one example of multiple sellers in an online marketplace;

FIG. 5 shows a block diagram illustrating one example of a user interface display for an online marketplace;

FIG. 6 shows a block diagram illustrating one example of selected sellers to fulfil an order with an online marketplace;

FIG. 7 shows a block diagram illustrating one example of a user interface display for a catalog item virtual fulfilment center application;

FIG. 8 shows a block diagram illustrating different examples of a user interface display for a catalog item virtual fulfilment center application based on the buyer geographic location;

FIG. 9 shows a flow diagram illustrating one example embodiment of a method for a catalog item virtual fulfilment center application; and

FIG. 10 shows a diagrammatic representation of machine in the example form of a computer system within which a set of instructions may be executed to cause the machine to perform any one or more of the methodologies discussed herein.

### DETAILED DESCRIPTION

Although the present invention has been described with reference to specific example embodiments, it will be evident that various modifications and changes may be made to these embodiments without departing from the broader spirit and scope of the invention. Accordingly, the specification and drawings are to be regarded in an illustrative rather than a restrictive sense.

A system and method for a catalog item virtual fulfillment center is described. The system determines whether an item from a search query on an online marketplace corresponds to a catalog item. The catalog item corresponds to an item sold at substantially the same price among different sellers of the online marketplace. A display of a menu of different shipping times and corresponding total costs is generated for the catalog item.

### System Architecture

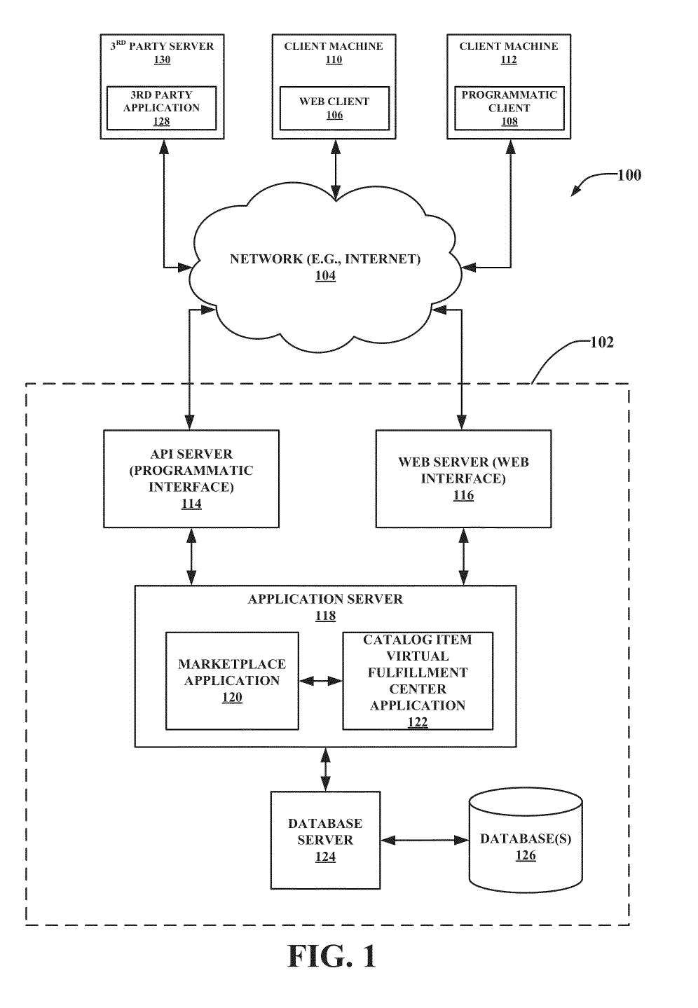

FIG. 1 is a network diagram depicting a network system 100, according to one embodiment, having a client-server architecture configured for exchanging data over a network. For example, the network system 100 may be a publication/publisher system where clients may communicate and exchange data within the network system 100. The data may pertain to various functions (e.g., online item purchases) and aspects (e.g., managing content and user reputation values) associated with the network system 100 and its users. Although illustrated herein as a client-server architecture as an example, other embodiments may include other network architectures, such as a peer-to-peer or distributed network environment.

A data exchange platform, in an example form of a marketplace application 120 and a catalog item virtual fulfillment center application 122, may provide server-side functionality, via a network 104 (e.g., the Internet) to one or more clients. The one or more clients may include users that utilize the network system 100 and more specifically, the marketplace application 120 and the the catalog item virtual fulfillment center application 122, to exchange data over the network 104. These transactions may include transmitting, receiving (communicating) and processing data to, from, and regarding content and users of the network system 100. The data may include, but are not limited to, content and user data such as user profiles; user attributes; product and service reviews and information, such as pricing and descriptive information; product, service, manufacturer, and vendor recommendations and identifiers; product and service listings associated with buyers and sellers; auction bids; and transaction data such as collection and payment, shipping transactions, shipping label purchases, and real time synchronization of financial journals, among others.

In various embodiments, the data exchanges within the network system 100 may be dependent upon user-selected functions available through one or more client or user interfaces (UIs). The UIs may be associated with a client machine, such as a client machine 110 using a web client 106. The web client 106 may be in communication with the marketplace application 120 via a web server 116. The UIs may also be associated with a client machine 112 using a programmatic client 108, such as a client application, or a third party server 130 with a third party application 128. It can be appreciated that in various embodiments the client machines 110, 112, or third party server 130 may be associated with a buyer, a seller, a third party electronic commerce platform, a payment service provider, a shipping service provider, a financial institution system, each in communication with the network-based publisher 102 and optionally each other. The buyers and sellers may be any one of individuals, merchants, or service providers, among other things.

Turning specifically to the marketplace application 120 and the catalog item virtual fulfillment center application 122, an application program interface (API) server 114, and a web server 116 are coupled to, and provide programmatic and web interfaces respectively to, one or more application servers 118. The application server 118 hosts one or marketplace applications 120 and the catalog item virtual fulfillment center application 122. The application server 118 is, in turn, shown to be coupled to one or more database servers 124 that facilitate access to one or more database(s) 126.

In one embodiment, the web server 116 and the API server 114 communicate and receive data pertaining to listings and transactions, among other things, via various user input tools. For example, the web server 116 may send and receive data to and from a toolbar or webpage on a browser application (e.g., web client 106) operating on a client machine (e.g., client machine 110). The API server 114 may send and receive data to and from an application (e.g., programmatic client 108 or third party application 128) running on another client machine (e.g., client machine 112 or 3^{rd} party server 130).

In one embodiment, the marketplace application 120 provides listings and price-setting mechanisms whereby a user may be a seller or buyer who lists or buys goods and/or services (e.g., for sale) published on the marketplace application 120.

In one embodiment, the catalog item virtual fulfillment center application 122 includes a system and a method for forming a virtual fulfillment center for catalog items listed in the marketplace application 120.

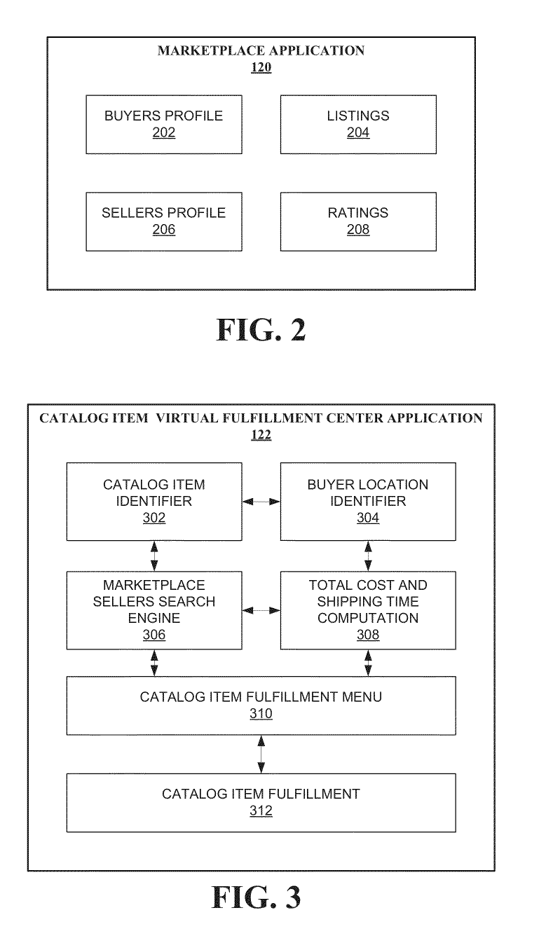

FIG. 2 shows a block diagram illustrating one example embodiment of the marketplace application 120. The marketplace application 120 includes, for example, a buyers profile module 202, a sellers profile module 204, a listings module 206, and a ratings module 208.

The buyers profile module 202 may be configured to generate and store profiles of buyers of the marketplace application 120. For example, the profiles of the buyers may include names, addresses (including shipping address), and transaction history.

The sellers profile module 206 may be configured to generate and store profiles of sellers of the marketplace application 120. For example, the profiles of the seller may include names, addresses (including shipping address), and transaction history.

The listings module 204 may be configured to generate and store listings from the sellers. The listings may identify items for sale in the marketplace application 120 including the price, condition of the items, and shipping information.

The ratings module 208 may be configured to generate and store ratings, including feedback ratings of buyers and sellers. In another embodiment, the ratings module 208 may also be configured to generate transaction volume and shipping volume on the marketplace application 120, or any other online marketplace.

FIG. 3 shows a block diagram illustrating one example embodiment of the catalog item virtual fulfillment center application 122. The catalog item virtual fulfillment center application 122 may include a catalog item identifier 302, a buyer location identifier module 304, a marketplace sellers search engine module 306, a total cost and shipping time computation module 308, a catalog item fulfillment menu module 310, and a catalog item fulfillment module 312.

The catalog item identifier module 302 determines whether an item from a search query on an online marketplace corresponds to a catalog item. In one embodiment, the catalog item is defined as an item sold at substantially the same price among different sellers of the online marketplace. For example, newly released video games or luxury purses typically sell for substantially the same price regardless of which seller sells the item in the online marketplace. Manufacturers may require that an item be sold no less than a preset suggested retail price.

The buyer location identifier module 304 determines a geographic location of the buyer. For example, the search query may be received from a mobile device of the buyer. The online marketplace application 120 may determine the geographic location of the buyer from the mobile device. In another embodiment, the buyer logs on to the online marketplace application 120. The catalog item virtual fulfillment center application 122 may access buyer profiles module 202 to determine the location of the buyer.

The marketplace sellers search engine 306 searches sellers with the catalog item in the online marketplace. In one embodiment, the marketplace sellers search engine 306 receives a search query comprising a catalog item. The catalog item identifier module 302 then searches an inventory database of the online marketplace, or the inventory or listings of sellers who show the catalog item in stock.

The total cost and shipping time computation module 308 uses the geographic location of the buyer to compute the shipping time and the total cost of for catalog item from sellers who show the catalog item in stock. Because the catalog item costs the same or substantially the same from every seller, the main variations between sellers are shipping costs, and shipping distances.

In one embodiment, the total cost and shipping time computation module 308 computes the total shipping cost between each seller with the catalog item and the buyer for each shipping timeframe (e.g., same-day delivery, same-day shipping, one-day shipping, two-day shipping, and so forth). In example embodiment, the total cost and shipping time computation module 308 associates the lowest total shipping cost with each shipping timeframe and records the corresponding seller. In another example embodiment, the total cost and shipping time computation module 308 associates the median lowest total shipping cost with each shipping timeframe and records one of the corresponding sellers based on the sellers profile and ratings. In yet another example, the seller might provide multiple shipping options such that, given a buyer in California and a seller in Texas with the only economic option, a seller in New York might offer expedited shipping that costs more but arrives sooner in addition to a standard economic option which is cheaper and arrives later. That is, the Total Cost and Shipping Time computation module 308 may include, but is not limited to, various shipping options provided by the seller, as well.

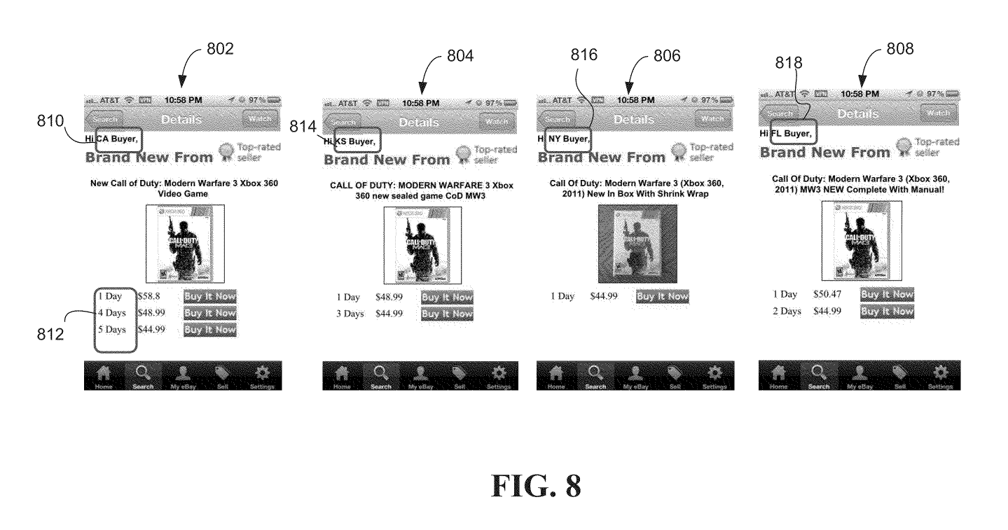

The catalog item fulfillment menu module 310 selects one seller from sellers with the catalog item with the lowest total cost for each corresponding shipping time timeframe. The catalog item fulfillment menu module 310 also generates a display of a menu of different shipping timeframes and corresponding total costs for the catalog item. It should be noted that the catalog item fulfillment menu module 310 displays a longer shipping time only if the total cost corresponding to the longer shipping time is less than a displayed shorter shipping time. FIGS. 7 and 8 illustrate different examples of menus as generated by the catalog item fulfillment menu module 310.

The catalog item fulfillment module 312 receives a selection of a shipping time and corresponding total cost from a buyer from the menu generated by the catalog item fulfillment menu module 310. The catalog item fulfillment module 312 then generates an order for the catalog item based on the selected shipping time and corresponding total cost between the buyer and the online marketplace. In other words, the buyer is placing an order with the online marketplace and not with a particular seller whom the buyer selected. The catalog item fulfillment module 312 then requests the seller associated with the selected shipping time and total cost to fulfill the order. As such, the seller fulfilling the order is transparent to the buyer.

### Example Catalog Item Virtual Fulfillment Scenarios

The following illustrates an example of catalog item virtual fulfillment center that enables an online marketplace to leverage the multiple network of sellers diversely geographically located. Each seller would act as a mini fulfillment warehouse for the online marketplace.

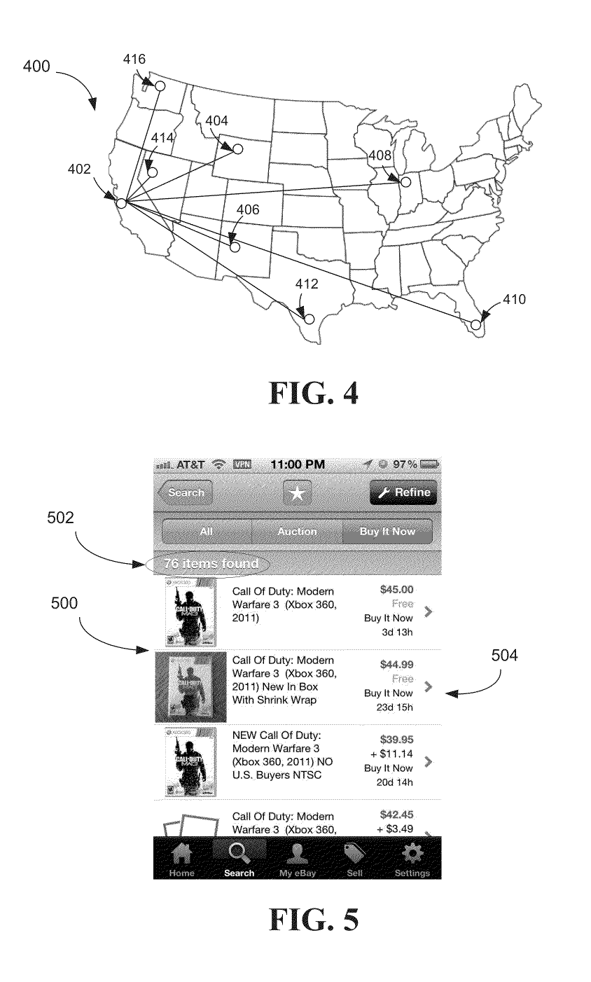

FIG. 4 shows a block diagram illustrating a map 400 showing multiple sellers 404, 406, 408, 410, 412, 414, and 416 for a buyer 402 in an online marketplace. Each seller offer their own different shipping price and shipping based on their respective location and the location of the buyer.

FIG. 5 shows a block diagram illustrating one example of a user interface display 500 corresponding to the sellers in FIG. 4. The user interface display 500 generates a display 502 of 76 items matching the buyer's search inquiry. Each item 504 displays a different price, a different shipping timeframe (e.g., one-day shipping, two-day shipping), and a different shipping cost (e.g., Free, $11.14, $3.49).

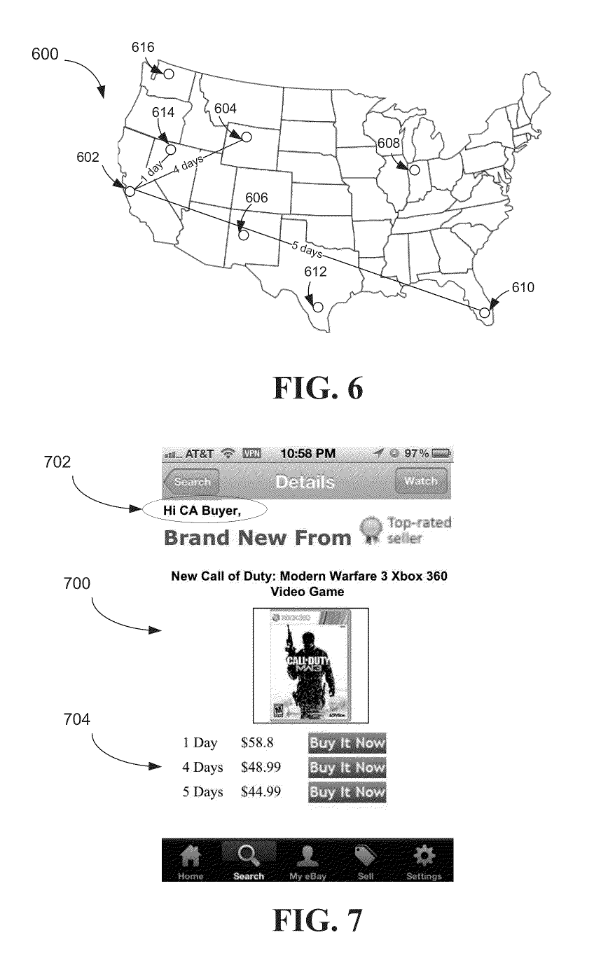

In contrast to FIG. 4, FIG. 6 shows a block diagram illustrating a map 600 one example of selected sellers 604, 614, and 610 to fulfil an order for a buyer 602 with an online marketplace. For example, the lowest shipping cost and catalog item cost for each shipping time frame is selected along with the corresponding seller. For one-day shipping, shipping cost and catalog item cost from seller 614 may be shown to the buyer 602. For four-day shipping, shipping cost and catalog item cost from seller 604 may be shown to the buyer 602. For five-day shipping, shipping cost and catalog item cost from seller 610 may be shown to the buyer 602.

FIG. 7 shows a block diagram illustrating one example of a user interface display 700 for a catalog item virtual fulfilment center application. The geographical location of the buyer or potential buyer is determined and displayed in a greeting 702. Three shipping options or shipping timeframes 704 are displayed: one-day shipping, four-day shipping, and five-day shipping. The total costs are displayed next to the corresponding shipping timeframes. As expected, total costs decrease with longer shipping timeframes.

FIG. 8 shows a block diagram illustrating different examples of user interface displays for a catalog item virtual fulfilment center application based on the buyer geographic location. The user interface display 802 displays a menu of shipping timeframes 812 based on the geographic location 810 of the buyer. The user interface displays 802, 806, and 808 dynamically change (new shipping timeframes and corresponding total costs) based on the geographic location 814, 816, and 818 of the buyer.

The following is a use case where after buyer places an order, the catalog item virtual fulfilment center application withhold the order until the end of the day and re-shuffle the orders for optimal shipping time and cost.

The following illustrates an example scenario:

On a specific day:

10:00 PST, 13:00 EST: buyer A in NY buys catalog item 1 from SF, and that's the only one available.

11:00 PST, 14:00 EST: catalog item 2 is listed in NY.

12:00 PST, 15:00 EST: buyer B in SF buys catalog item 2 from NY.

So buyer A in NY ends up buying from SF, and buyer B in SF ends up buying from NY, and the shipment crossed each other. Item 2 was not shown to buyer A because item 2 was not listed at that time. Also, item 1 was not shown to buyer B because it was sold at that time.

The catalog item virtual fulfilment center application as presently described may withhold the orders from the sellers until the end of the day, say 13:00 PST and 16:00 EST. At that time, before sending the orders to sellers of item 1 and 2 respectively, the catalog item virtual fulfilment center application determines that it is more optimal to have item 2 from NY sent to buyer A in NY and item 1 from SF sent to buyer B in SF. The catalog item virtual fulfilment center application can modify the orders and send them out that way, still in time for sellers to package and ship. As such, both buyers will get their items earlier.

### Catalog Item Cirtual Fulfillment Center Operation

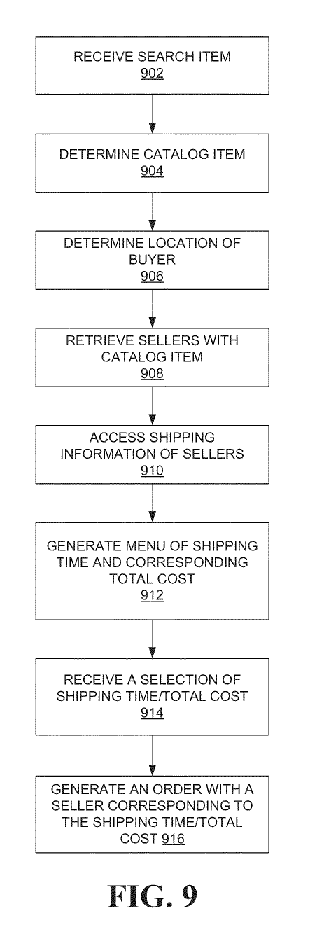

FIG. 9 shows a flow diagram illustrating one example embodiment of a method for a catalog item virtual fulfilment center application. At operation 902, the catalog item virtual fulfilment center application receives a search query for an item on an online marketplace.

At operation 904, the catalog item virtual fulfilment center application determines whether the item from the search query on the online marketplace corresponds to a catalog item. The catalog item corresponds to an item sold at substantially the same price among different sellers of the online marketplace. In one embodiment, the catalog item identifier module 302 determines whether the item from the search query on the online marketplace corresponds to a catalog item.

At operation 906, the catalog item virtual fulfilment center application determines a geographic location of the buyer. In one embodiment, the buyer location identifier module 304 determines a geographic location of the buyer who submitted the search query.

At operation 908, the catalog item virtual fulfilment center application searches for sellers with the catalog item in the online marketplace. In one embodiment, the marketplace sellers search engine 306 searches for sellers with the catalog item in the online marketplace.

At operation 910, the catalog item virtual fulfilment center application accesses shipping information and catalog cost for each seller with the catalog item. The catalog item virtual fulfilment center application also determines the geographic location of the buyer to compute the shipping time and total cost of the catalog item from sellers with the catalog item. In one embodiment, the total cost and shipping time computation module 308 computes the shipping time and total cost of the catalog item from sellers with the catalog item based on the geographic location of the buyer.

At operation 912, the catalog item virtual fulfilment center application generates a display of a menu of different shipping times and corresponding total costs for the catalog item. The total cost includes for example, the catalog item cost and the shipping cost corresponding to the shipping time. In one embodiment, the catalog item fulfillment menu 310 generates a display of a menu of different shipping times and corresponding total costs for the catalog item.

In one embodiment, the catalog item virtual fulfilment center application selects only one seller from sellers with the catalog item for each corresponding shipping time based on the ratings of the sellers. In another embodiment, the catalog item virtual fulfilment center application select one seller from sellers with the catalog item with the lowest total cost for each corresponding shipping time.

In one embodiment, the catalog item virtual fulfilment center application displays a longer shipping time only if the total cost corresponding to the longer shipping time is less than a displayed shorter shipping time.

At operation 914, the catalog item virtual fulfilment center application receives a selection of a shipping time and corresponding total cost from a buyer. In one embodiment, the catalog item fulfillment module 312 receives the selection of the shipping time and corresponding total cost from the buyer.

At operation 916, the catalog item virtual fulfilment center application generates an order for the catalog item based on the shipping time and corresponding total cost between the buyer and the online marketplace. The catalog item virtual fulfilment center application may also request the seller associated with the selected shipping time and total cost to fulfill the order. The seller may be transparent to the buyer. In one embodiment, the operation 916 may be performed by the catalog item fulfillment module 312.

### Example Computer System

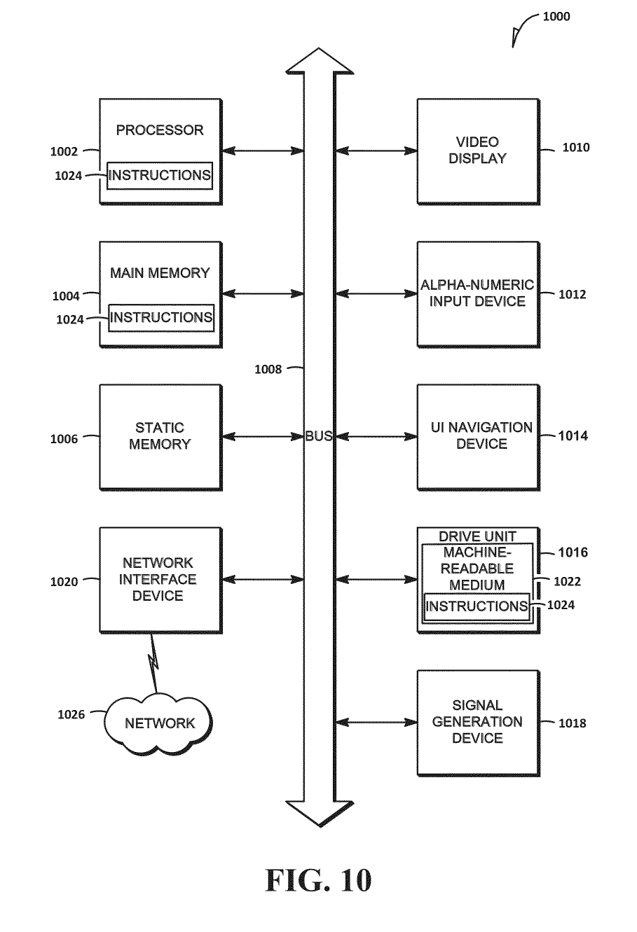

FIG. 10 shows a diagrammatic representation of a machine in the example form of a computer system 1000 within which a set of instructions may be executed causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1000 includes a processor 1002 (e.g., a central processing unit (CPU), a graphics processing unit (GPU) or both), a main memory 1004 and a static memory 1006, which communicate with each other via a bus 1008. The computer system 1000 may further include a video display unit 1010 (e.g., a liquid crystal display (LCD) or a cathode ray tube (CRT)). The computer system 1000 also includes an alphanumeric input device 1012 (e.g., a keyboard), a user interface (UI) navigation device 1014 (e.g., a mouse), a disk drive unit 1016, a signal generation device 1018 (e.g., a speaker) and a network interface device 1020.

The disk drive unit 1016 includes a machine-readable medium 1022 on which is stored one or more sets of instructions and data structures (e.g., software 1024) embodying or utilized by any one or more of the methodologies or functions described herein. The software 1024 may also reside, completely or at least partially, within the main memory 1004 and/or within the processor 1002 during execution thereof by the computer system 1000, with the main memory 1004 and the processor 1002 also constituting machine-readable media.

The software 1024 may further be transmitted or received over a network 1026 via the network interface device 1020 utilizing any one of a number of well-known transfer protocols (e.g., HTTP).

While the machine-readable medium 1022 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present invention, or that is capable of storing, encoding or carrying data structures utilized by or associated with such a set of instructions. The term “machine-readable medium” shall accordingly be taken to include, but not be limited to, solid-state memories, optical media, and magnetic media.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

The Abstract of the Disclosure is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment.

What is claimed is:

1. A catalog item virtual fulfillment center system comprising:
a catalog item identifier module configured to determine whether an item from a search query on an online marketplace corresponds to a catalog item, the catalog item corresponding to an item sold at substantially the same price among different sellers of the online marketplace; and
a catalog item fulfillment menu module configured to generate a display of a menu of different shipping times and corresponding total costs for the catalog item.

2. The catalog item virtual fulfillment center system of claim 1, further comprising:
a buyer location identifier module configured to determine a geographic location of the buyer;
a marketplace sellers search engine configured to search sellers with the catalog item in the online marketplace; and
a total cost and shipping time computation module configured to use the geographic location of the buyer to compute the shipping time and total cost of the catalog item from sellers with the catalog item.

3. The catalog item virtual fulfillment center system of claim 2, wherein the catalog item fulfillment menu is configured to select only one seller from sellers with the catalog item for each corresponding shipping time based on the ratings of the sellers.

4. The catalog item virtual fulfillment center system of claim 2, wherein the catalog item fulfillment menu is configured to select one seller from sellers with the catalog item with the lowest total cost for each corresponding shipping time.

5. The catalog item virtual fulfillment center system of claim 4, further comprising:
a catalog item fulfillment module configured to receive a selection of a shipping time and corresponding total cost from a buyer, to generate an order for the catalog item based on the shipping time and corresponding total cost between the buyer and the online marketplace, and to request the seller associated with the selected shipping time and total cost to fulfill the order, the seller transparent to the buyer.

6. The catalog item virtual fulfillment center system of claim 1, wherein the total cost comprises the catalog item cost and the shipping cost corresponding to the shipping time.

7. The catalog item virtual fulfillment center system of claim 1, wherein the menu comprises a same-day pickup time or a one-day shipping time.

8. The catalog item virtual fulfillment center system of claim 1, wherein the catalog item fulfillment menu module displays a longer shipping time only if the total cost corresponding to the longer shipping time is less than a displayed shorter shipping time.

9. A method for a catalog item virtual fulfillment center comprising:
determining whether an item from a search query on an online marketplace corresponds to a catalog item, the catalog item corresponding to an item sold at substantially the same price among different sellers of the online marketplace; and
generating, using a processor, a display of a menu of different shipping times and corresponding total costs for the catalog item.

10. The method of claim 9, further comprising:
determining a geographic location of the buyer;
searching sellers with the catalog item in the online marketplace; and
using the geographic location of the buyer to compute the shipping time and total cost of the catalog item from sellers with the catalog item.

11. The method of claim 10, further comprising:
selecting only one seller from sellers with the catalog item for each corresponding shipping time based on the ratings of the sellers.

12. The method of claim 10, further comprising:
selecting one seller from sellers with the catalog item with the lowest total cost for each corresponding shipping time.

13. The method of claim 12, further comprising:
receiving a selection of a shipping time and corresponding total cost from a buyer;
generating an order for the catalog item based on the shipping time and corresponding total cost between the buyer and the online marketplace; and
requesting the seller associated with the selected shipping time and total cost to fulfill the order, the seller transparent to the buyer.

14. The method of claim 9, wherein the total cost comprises the catalog item cost and the shipping cost corresponding to the shipping time.

15. The method of claim 9, wherein the menu comprises a same-day pickup time or a one-day shipping time.

16. The method of claim 9, further comprising:
displaying a longer shipping time only if the total cost corresponding to the longer shipping time is less than a displayed shorter shipping time.

17. A non-transitory computer-readable storage medium storing a set of instructions that, when executed by a processor, cause the processor to perform operations, comprising:
determining whether an item from a search query on an online marketplace corresponds to a catalog item, the catalog item corresponding to an item sold at substantially the same price among different sellers of the online marketplace; and
generating a display of a menu of different shipping times and corresponding total costs for the catalog item.

18. The non-transitory computer-readable storage medium of claim 17, further comprising:
determining a geographic location of the buyer;
searching sellers with the catalog item in the online marketplace; and
using the geographic location of the buyer to compute the shipping time and total cost of the catalog item from sellers with the catalog item.

19. The non-transitory computer-readable storage medium of claim 18, further comprising:
selecting one seller from sellers with the catalog item with the lowest total cost for each corresponding shipping time.

20. The non-transitory computer-readable storage medium of 19, further comprising:
receiving a selection of a shipping time and corresponding total cost from a buyer;
generating an order for the catalog item based on the shipping time and corresponding total cost between the buyer and the online marketplace; and
requesting the seller associated with the selected shipping time and total cost to fulfill the order, the seller transparent to the buyer.
